(19) United States
(12) Patent Application Publication
(10) Pub. No.: US 2016/0044060 A1
(43) Pub. Date: Feb. 11, 2016

(54) POLICY SYNCHRONIZATION FOR MULTIPLE DEVICES

(71) Applicant: EMPIRE TECHNOLOGY DEVELOPMENT LLC, Wilmington, DE (US)

(72) Inventor: Soma Biswas, Lausanne (CH)

(21) Appl. No.: 14/421,095

(22) PCT Filed: Mar. 26, 2014
(86) PCT No.: PCT/US2014/031823

§ 371 Date: Feb. 11, 2015

(51) Int. Cl. H04L 29/06

(52) U.S. Cl. CPC H04L 63/20; H04L 63/10

(57) ABSTRACT

Technologies are generally described for generating policies for multiple devices associated with a user. In some examples, one or more policies associated with a user may be accessed. The policies may pertain to one or more computing devices associated with the user. The capabilities of an additional computing device to be associated with the user may be determined. Based on the determined capabilities, which of the one or more policies are applicable to the additional computing device may be identified. Based on the identified policies, a default set of policies for the additional computing device may be automatically generated.

### BACKGROUND

Users of computing devices may have access to or own multiple computing devices such as tablets, smartphones, and laptops. Many of these devices, such as smartphones. may be capable of collecting personal real-time information about their users (e.g., location and specific activity) with the help of sensors embedded in the smartphones. While this information can be useful for providing context-relevant services to users, the information can also be misused with negative privacy implications. Such misuse is becoming an increasing concern.

To alleviate such privacy concerns, mobile platforms allow users to specify privacy policies that restrict the actions that can be performed by applications and the types of information that can be collected by the applications. Unfortunately, the privacy policy definition process can be cumbersome and time consuming, which may lead to users neglecting to set their policies and leaving the users vulnerable to privacy threats. Such threats can include account or service hijacking, phishing, fraud, and exploitation of software vulnerabilities. Credentials and passwords can be reused, which amplifies the impact of such attacks.

For the policies to be effective, multiple parameters with respect to data types and allowed actions need to be specified for each application. This requires the users to classify their data, identifying the sensitive data types, and identify those that need to be protected from an application based on its capabilities, trustworthiness, functionality, and the like.

### SUMMARY

Disclosed herein are methods and systems for generating policies for multiple devices associated with a user. In some embodiments, a method for generating policies for multiple devices associated with a user may include accessing one or more policies associated with a user. The policies may pertain to one or more computing devices associated with the user. The capabilities of an additional computing device to be associated with the user may be determined. Based on the determined capabilities, which of the one or more policies are applicable to the additional computing device may be identified. Based on the identified policies, a default set of policies for the additional computing device may be automatically generated.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts an example where policies on a current device are serialized and sent to a new device.

FIG. 2 depicts an example user interface with a policy settings view for multiple devices.

FIG. 3 depicts an example where a third party maintains a comprehensive set of policies.

FIG. 4 illustrates an example of an operational procedure for adapting policies.

FIG. 5 depicts an example computing environment wherein aspects of the present disclosure can be implemented.

FIG. 6 depicts an example computing environment wherein aspects of the present disclosure can be implemented.

FIG. 7 depicts an example operational environment for practicing aspects of the present disclosure.

FIG. 8 depicts an example computing system wherein aspects of the present disclosure can be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

It may be useful to provide users having or owning multiple computing devices with the ability to configure settings on one computing device and experience the effects on the user's other computing devices. Disclosed herein are technologies, including methods and systems to efficiently synchronize policies among multiple computing devices. In some embodiments, policies may be synchronized in an incremental fashion. For example, policies may be configured on a new device joining the user's computing device ecosystem based on already configured policies in existing computing devices.

At a high level, mobile privacy policies control the interaction between applications (either installed on the device or web-based HTML5 devices, for example) and phone resources (e.g., camera, microphone, sensors, Bluetooth, NFS, Wi-Fi). The policies typically control which resources can be accessed by which applications, how frequently the resources can be accessed, in what context the resources can be accessed, and so on. A user may be reluctant to take the time and effort to configure his/her privacy policies. Hence, the burden of having to configure policies from scratch on multiple computing devices can be well appreciated. Accordingly, a semi-automated tool for privacy policies that synchronizes policies between new and existing computing devices and adapts existing policies according to the characteristics of the new computing device can help alleviate some of these issues.

Another recent trend is that of ‘Bring Your Own Device’ (BYOD). With the proliferation of smart devices and the increase in the number of available options, consumers may have their own “favorite” device, which is also the device that they would like to use in their work environment. This has led to the “BYOD to work” scenario with more and more employees preferring to use the same device for both work and in personal life. As expected, BYOD leads to significant challenges for system administrators from a security/privacy perspective. Given the host of mobile platforms and plethora of applications that users would like to use, it is a daunting task for administrators to maintain computing devices and applications. Accordingly, the present disclosure directed to adapting privacy policies based on existing policies and characteristics of a new computing device can help address such issues.

In various embodiments, privacy policies may be adapted for computing devices based on policies already set by users on existing computing devices. In at least some embodiments, a set of attributes and properties pertaining to privacy and mobility may be identified based on which existing policies can be defined and adapted. The adaptation process can be modified to be personalized to the user according to the user's usage patterns. Furthermore, the adaptation process may be implemented so as to require minimal modifications to existing policies and require minimal user feedback. In at some least embodiments, such a policy adaptation function may be provided as a service by a service provider that may, for example, provide the policy adaptation function as a service available via the Internet. The policy adaptation function may also be implemented on one or more of a user's computing devices.

In one embodiment, a summary view of applications and corresponding policies configured on multiple user devices may be provided. For example, the service provider may provide the summary view that is accessible via a web browser. Alternatively, the user may be able to access the summary view via a user interface on the user's computing device. Such a summary view of the configured applications and policies on the different computing devices can allow users to make informed decisions while setting or adapting policies for new computing devices.

Mobile device privacy policies may pertain to resources on the mobile device that can be accessed by an application. Authorization to access such resources may take place during application installation when the user is presented with the list of resources that need to be accessed in order for the application to function. Once the user agrees to the requested list of access requests, the application may have or may be granted unlimited access to those resources at run-time. The present disclosure considers such policies as well as policies that are more expressive than a list of allowed resources which may be applicable in other scenarios. For example, the disclosure contemplates policies that allow the users to specify access parameters, such as:
Frequency of access: How frequently is an application allowed to access a resource? This prevents privacy violations of the type where, for example, a weather application requiring access to the user's location to display weather information corresponding to the user's current city may poll the user's location every few minutes to obtain the user's location history.
Context: The location, time, and surrounding environment where a specific resource can be accessed.
Persistence: The application's ability to retain information across invocations of the application. This can be achieved by either storing or serializing application data in local storage (requiring file access) or in cloud storage (requiring network access) that can then be retrieved on re-invocation.
Composition: the ability of applications to interact in a collaborative fashion with each other in order to provide additional functionality. For example, this can be achieved via inter-process communication techniques that allow an application to invoke or interact with another application. Different platforms may support different application interaction techniques, e.g., DBus, services framework in Qt, Launchers and Choosers in Windows Phone 7, etc.

To provide an illustrative example, a privacy policy for a camera application that requires access to the camera subsystem may also request access to the address book to tag contacts in photos taken with contacts in the user's contacts list), the device's location to geo-tag photos, the file system to store photos in the local hard disk, and the network to share/post photos with online social networking sites. In one embodiment, resources can be determined as follows:

```
    Policy (Camera_App):-
    Camera (‘F_High’, NOT [‘Office’], ‘Yes’) AND Contacts
(‘F_Low’, _, ‘No’) AND Location (‘F_Med’, _, ‘No’) AND
File (‘F_High’, _, _) AND Network (‘F_High’, _, _) AND
Compose (Face_Recognition_App, ‘F_Off’)
```

The policy may be formulated in standard logical form using AND, OR, NOT, and other logical operators. For the device resources, the first parameter may denote the allowed frequency of access (F_High, F_Med, F_Low). The second parameter may refer to contextual parameters. For example, NOT [‘Office’] specifies that the camera cannot be used in location Office. The third parameter may indicate whether data corresponding to that resource is to be persisted (‘Yes/No’). For example, a policy may specify that while the camera data (e.g., photos) can be persisted, any retrieved location and contacts data cannot be persisted for future use. The application may also be allowed to interact with a facial recognition application as indicated by the Compose predicate. The second parameter may indicate the type of interaction allowed with ‘F_Sim’, ‘F_One’, ‘F_Off’, indicating modes where the two applications can run simultaneously. For example, Application 1's state may be saved and placed into hibernation before Application 2 can run and Application 1 resumes after Application 2 terminates. Interaction between the two applications may occur via offline sharing methods, e.g., both applications having access to a file/space on local disk.

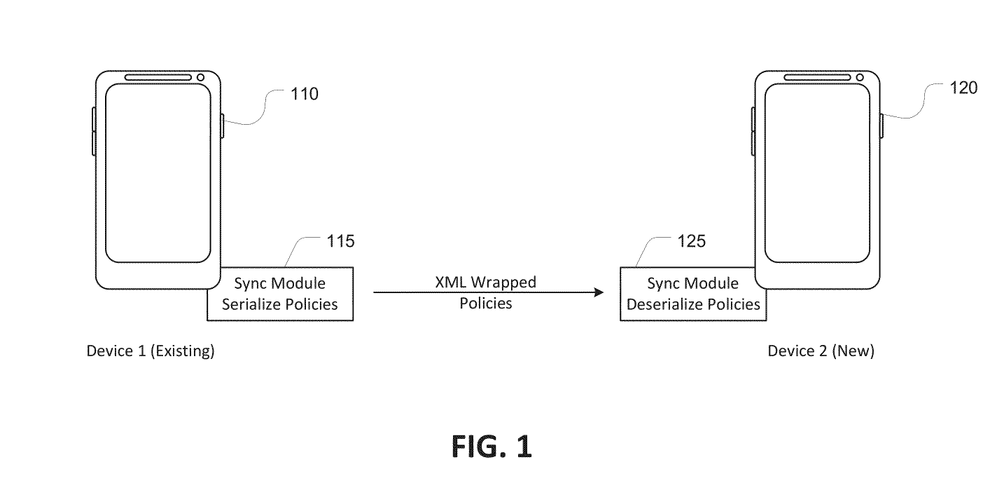

In one embodiment, synchronizing policies with a new device may comprise serializing the policies to an interoperable format. For example, Extensible Markup Language (XML) may be used to serialize the policies to an interoperable format. The serialized policies may be sent to the new device and de-serialized on the new device. FIG. 1 illustrates an example where policies on a current device are serialized and sent to a new device. An existing device 110 may include a synchronization module 115 configured to serialize policies. The serialized policies may be sent as XML wrapped policies to a new device 120 that includes a synchronization module 125 configured to de-serialize the received data to generate the policies from existing device 110.

One example of XML serialization of a policy for a camera application

(“Camera_App”) may include:
<app name=”Camera_App”>
<credential name = ”Camera” >
<parameter name = “frequency” value=”F_High” />
<parameter name = “context” value=”NOT [‘Office’]” />
<parameter name = “persist” value=”Yes” />
</credential>
<credential name = “Location” >
<parameter name = “frequency” value=”F_Med” />
<parameter name = “persist” value=”No” />
</credential>
...
<compose>
<link name = “Face_Recognition_App”>
</compose>
</app>
<app name=”Face_Recognition_App”>
...
</app>

In addition to synchronizing/replicating privacy policies, replicating policies can also be viewed as an aspect of application synchronization, where the same applications are installed on the new device as on the old device. Once replicated/transferred, the policies may be adapted with respect to system characteristics and usage patterns. The table below illustrates an example comparison between old and new devices for adapting privacy policies.

| | | New; Old Device Difference |
|---|---|---|
| | Resources/Sensors | −Bluetooth; +Accelerometer |
| Device | Persistence | −; + |
| Characteristics | Composition | −F_Off; +F_Sim |
| | Location | −Office; +Home |
| Usage | Temporal | −Day; +Evening |
| pattern/Context | Environment | −Colleagues; +Family, +Friends |

In the table above, the usage pattern parameter values may be populated by the user, and can be gathered from the user via a user interface. For example, the user interface may present a list of logical locations and the user may be able to select locations where the device may be used. In one example, previous selections as specified in the policies with respect to prior devices can be presented to the user. In one embodiment, device characteristics can be populated by a system administrator or an appropriate expert, by the user based on device specifications, or by the manufacturers. In one embodiment, a device specification ontology may be standardized to allow for manufacturers and other parties to provide such information in a standardized way.

Referring to the table above, policies may be refined with respect to the negative (−) values in the table. (−) may denote that a parameter is missing in the new device by comparison to the old device. For instance, with respect to usage with respect to location, if the new device is not planned to be used in the office (−Office), then that restriction can be removed from the policy for Camera_App, leading to the following policy:

```
    Policy (Camera_App):-
    Camera (‘F_High’, _, ‘Yes’) AND Contacts (‘F_Low’, _, ‘No’)
AND Location (‘F_Med’, _, ‘No’) AND File (‘F_High’, _, _) AND
Network (‘F_High’, _, _) AND Compose
(Face_Recognition_App, ‘F_Off’)
```

In one embodiment, restrictions that are no longer relevant may be removed. This may simplify rules and improve run-time performance efficiency because validation typically requires processing power and time. Continuing with the above table, it can be noted that the ‘F_Off’ composition mechanism is no longer supported by the new device OS/platform (−‘F_Off’). This suggests that the composition with Face_Recognition_App is also no longer supported. While removing these policies may provide further simplification, removal may also have the disadvantage of limiting application functionality. Accordingly, to minimize the effect on application functionality, the positive (+) values in the table may be evaluated.

The (+) values may refer to additional device and usage parameters that are supported by the new device but were not supported by the old device. Continuing with the table, the composition mechanism ‘F_Sim’ is supported instead of ‘F_Off’ so it may be possible for Camera_App to interact with Face_Recognition_App, with further verification by the application developer. In one embodiment, if supported from a technical or implementation perspective, permission may be obtained from the user or administrator for the application to use the F_Sim composition primitive. Similar approval may be acquired from the user or administrator with respect to other parameters, such as an environment parameter which states that the new device is intended to be used in the proximity of friends and family. Another example restriction is a restriction on network sharing when family members are in the vicinity of the device. Continuing with the example, the restrictions may be implemented in a modified set of policies adapted for the new device based on existing policies as follows:

```
    Policy (Camera_App):-
    Camera (‘F_High’, _, ‘Yes’) AND Contacts (‘F_Low’, _, ‘No’)
AND Location (‘F_Med’, _, ‘No’) AND File (‘F_High’, _, _) AND
Network (‘F_High’, NOT [‘Family’], _) AND Compose
(Face_Recognition_App, ‘F_Sim’).
```

In some embodiments, incremental adaptation may be used to adapt policies for a third computing device based on existing policies implemented on two existing computing devices. The described principles may further be applied to adapt policies for an n^{th} computing device based on (n−1) existing computing device policies.

As discussed, policies for a second computing device can be adapted based on existing policies for the first computing device. In one embodiment, when a third device is added, the policies for the existing computing devices which the third computing device resembles more in terms of relevant policy parameters may be used. For example, based on the parameters in the table above, an existing computing device may be selected to generate a set of policies for the new computing device. Selection of an existing computing device may be made in accordance with one or more criterion. In one embodiment, one criterion may be to minimize the adaptation and therefore the required user feedback when generating the new policies. In some embodiments, such a criterion can be implemented as a weighted comparison with weights assigned to the parameters. The weights can be assigned based on user or administrator feedback.

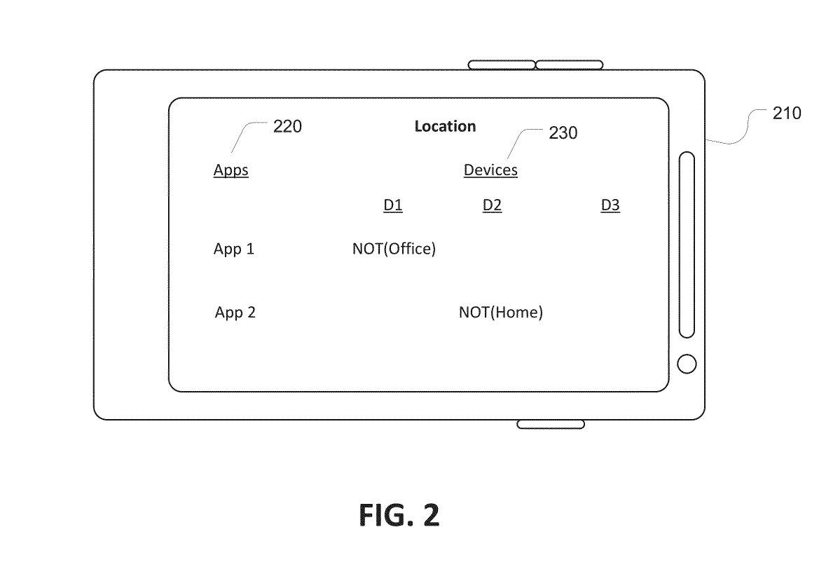

After selecting one of the existing devices in the manner described, it may be determined that there are differences in terms of some of the parameters. For example, assume that policies for the third computing device is being adapted based on the second computing device's policies because the second computing device is more similar to the third computing device than the first computing device based on a weighted comparison of their respective device and usage characteristics. Furthermore, assume that the third computing device differs in terms of being used in the location ‘Office’ as compared to the location ‘Home’ for the second computing device. In this example, general user feedback may be needed to adapt policies with respect to location ‘Office.’ In one embodiment, during the user feedback process, the user may be provided reminders of the existing settings with respect to ‘Office’ implemented in other computing devices. An example user interface for this scenario is illustrated in FIG. 2 which shows a policy settings view 210 for multiple computing devices. A listing of applications 220 may be provided that may include computing devices 230 associated with the user. The list of user computing devices 230 may include indications of policy parameters associated with the applications such as NOT(Office) and NOT(Home).

In one embodiment, when adding a new computing device to a set of existing computing devices that implement policies for a user, one of the existing computing devices may be selected to determine policies for the new device. An existing computing device may be selected based on similarity to the newly added computing device in terms of policy parameters as discussed herein. For example, selection of an existing computing device may be made in accordance with one or more criterion for to minimizing the adaptation of policies for the existing computing device when generating new policies for the newly added computing device. In some embodiments, such a criterion may include a number of common hardware features between an existing computing device and the newly added computing device.

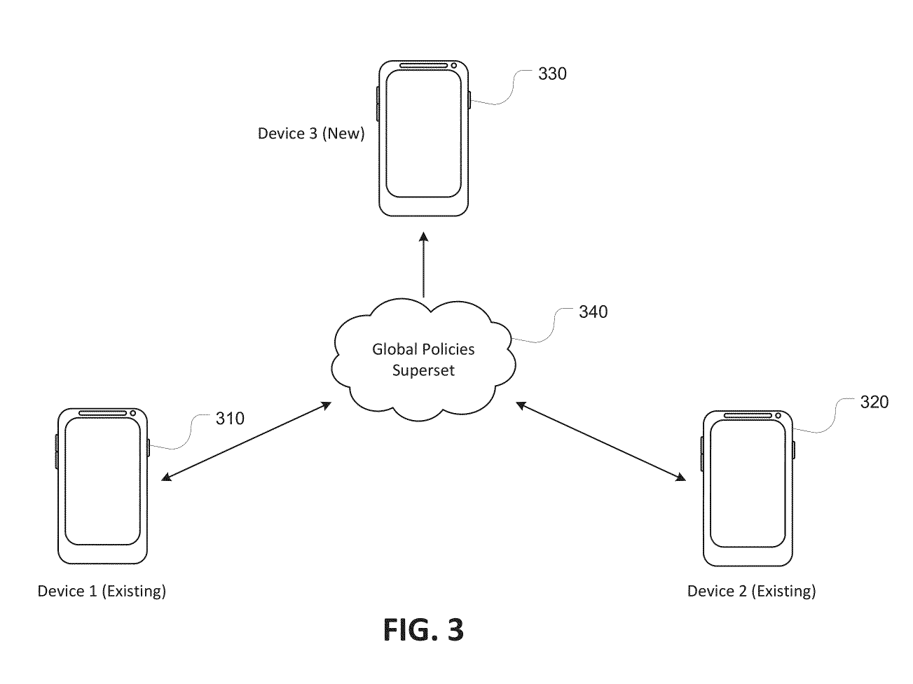

The user or administrator may be provided reminders as to settings on the existing computing devices. In some embodiments, a superset of policies for all of the user's registered computing devices may be maintained. A service provider may maintain such a superset on a server accessible via the Internet. Alternatively, the user may select a computing device that maintains such a superset. FIG. 3 illustrates one embodiment where a trusted third party such as a service provider operating in the cloud or one of the user's existing computing devices configured as a master device may maintain a superset of policies. In some embodiments, the generation of policies for new computing devices may be managed by such a trusted third party or master device. Referring to FIG. 3, existing computing devices 310 and 320 may communicate with a third party that may manage and store the user's policies as a global policies superset 340. When the user adds a third computing device 330, the third computing device 330 may communicate with the third party to receive policies based on the global policies superset 340.

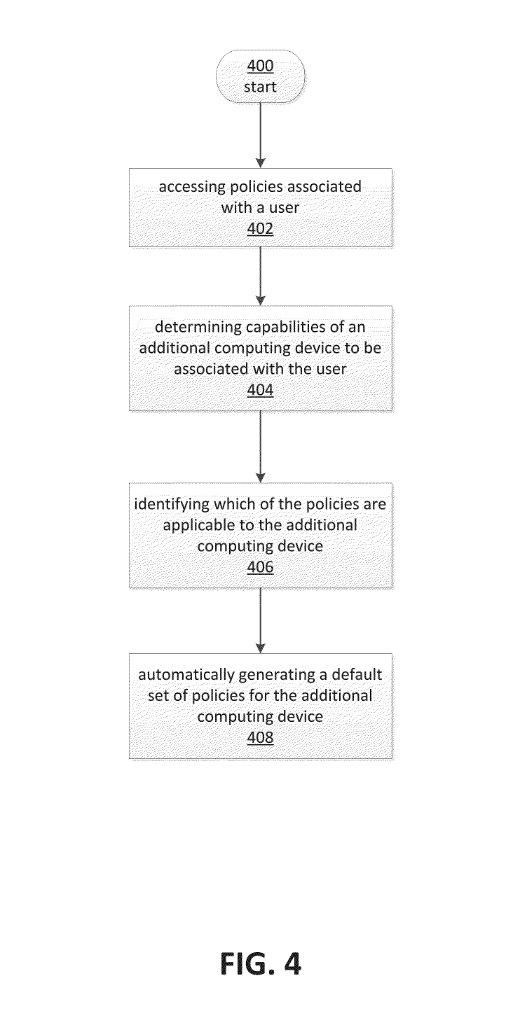

FIG. 4 illustrates an example of an operational procedure for adapting policies including operations 400, 402, 404, 406, and 408. In one embodiment, the operational procedure may be implemented on a computing device. The computing device may comprise at least one processor and a memory communicatively coupled to the processor. The memory may have stored thereon computer instructions that implement the operational procedure when executed by the processor. Referring to FIG. 4, operation 400 begins the operational procedure. Operation 400 may be followed by operation 402. Operation 402 illustrates accessing one or more policies associated with a user. The policies may pertain to one or more computing devices associated with the user.

Operation 402 may be followed by operation 404. Operation 404 illustrates determining capabilities of an additional computing device to be associated with the user. Operation 404 may be followed by operation 406. Operation 406 illustrates, based on the determined capabilities, identifying which of the policies are applicable to the additional computing device.

Operation 406 may be followed by operation 408. Operation 408 illustrates, based on the identified policies, automatically generating a default set of policies for the additional computing device. In some embodiments, the default set of policies may be automatically generated by incrementally adapting one of the identified policies. In one embodiment, the default set of policies may be automatically generated by removal of restrictions that are no longer relevant to the additional computing device. In other embodiments, the default set of policies may be automatically generated by identifying capabilities supported by the additional computing device that are not supported by current computing devices associated with the user and generating default policies based on policies pertaining to at least one similar capability.

In some embodiments, the default set of policies may be based on usage patterns associated with the user. The usage patterns may, for example, comprise one or more of frequency of access, context, persistence, and composition. The default set of policies may be serialized to an interoperable format and the serialized policies may be sent to the additional computing device.

In the disclosed detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

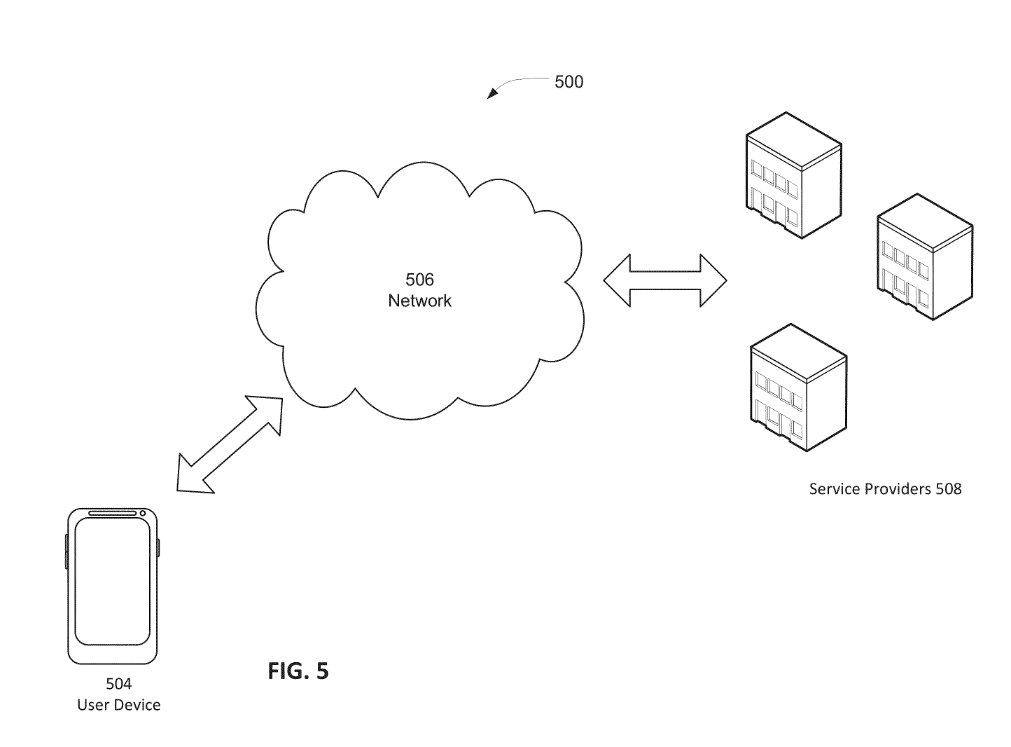

FIG. 5 depicts an example computing environment wherein aspects of the present disclosure can be implemented. In particular, FIG. 5 depicts an illustrative operating environment 500 that includes service providers 508 for providing computing resources. Service providers 508 can provide computing resources and services for executing applications and providing data services on a continuous or an as-needed basis. The computing resources and services provided by service providers 508 may include various types of resources and services, such as data processing resources, data storage resources, data communication resources, and the like.

The computing resources and services provided by service providers 508 may be enabled by one or more individual data centers that may be facilities utilized to house and operate computer systems and associated components.

The customers and other consumers of service providers 508 may access the computing resources and services provided by service providers 508 over a network 506. It should be appreciated that a local-area network (“LAN”), the Internet, or any other networking topology known in the art that connects service providers 508 to remote consumers may be utilized. It should also be appreciated that combinations of such networks might also be utilized.

A user device 504 may be a computer utilized by a customer or other consumer of service providers 508. For instance, user device 504 may be a server computer, a desktop or laptop personal computer, a thin client, a tablet computer, a wireless telephone, a personal digital assistant (“PDA”), an e-reader, a game console, or any other computing device capable of accessing service providers 508.

User device 504 may be utilized to configure aspects of the computing resources provided by service providers 508 or access services provided by service providers 508. For example, service providers 508 may provide a Web interface through which aspects of its operation may be configured or accessed through the use of a Web browser application program executing on user device 504. Alternatively, a stand-alone application program executing on user device 504 might access an application programming interface (“API”) exposed by service providers 508 for accessing the computing resources or performing the configuration operations. Other mechanisms for configuring the operation of service providers 508, including deploying updates to an application or accessing the computing resources might also be utilized.

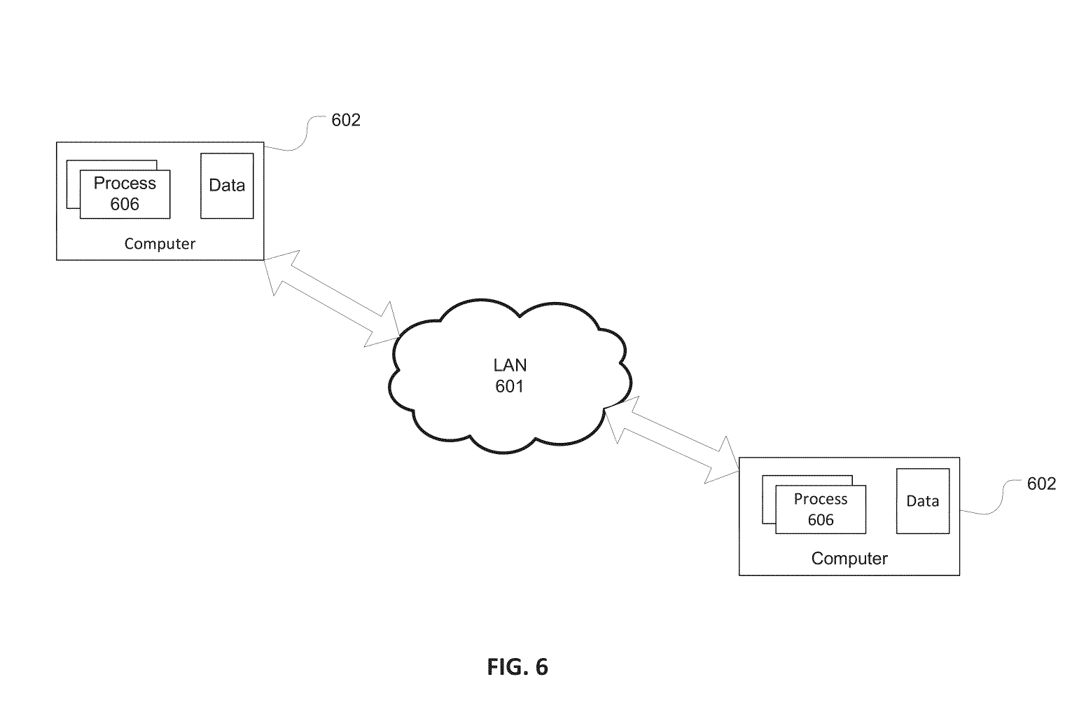

FIG. 6 depicts an example computing environment wherein aspects of the present disclosure can be implemented. As depicted, FIG. 6 shows computers 602 for executing processes 606. In the example shown in FIG. 6, a LAN 601 is utilized to interconnect computers 602. It should be appreciated that the network topology illustrated in FIG. 6 has been simplified and that many more networks and networking devices may be utilized to interconnect the various computing systems disclosed herein. These network topologies and devices should be apparent to those skilled in the art.

Cloud computing generally refers to a computing environment for enabling on-demand network access to a shared pool of computing resources (e.g., applications, servers, and storage) such as those described above. Such a computing environment may be rapidly provisioned and released with minimal management effort or service provider interaction. Cloud computing services typically do not require end-user knowledge of the physical location and configuration of the system that delivers the services. The services may be consumption-based and delivered via the Internet. Many cloud computing services involve virtualized resources such as those described above and may take the form of web-based tools or applications that users can access and use through a web browser as if they were programs installed locally on their own computers.

Cloud computing services are typically built on a suitable computing platform. For some applications, such as those running inside an organization's data center, this platform may include an operating system and a data storage service configured to store data. Applications running in the cloud may utilize a similar platform.

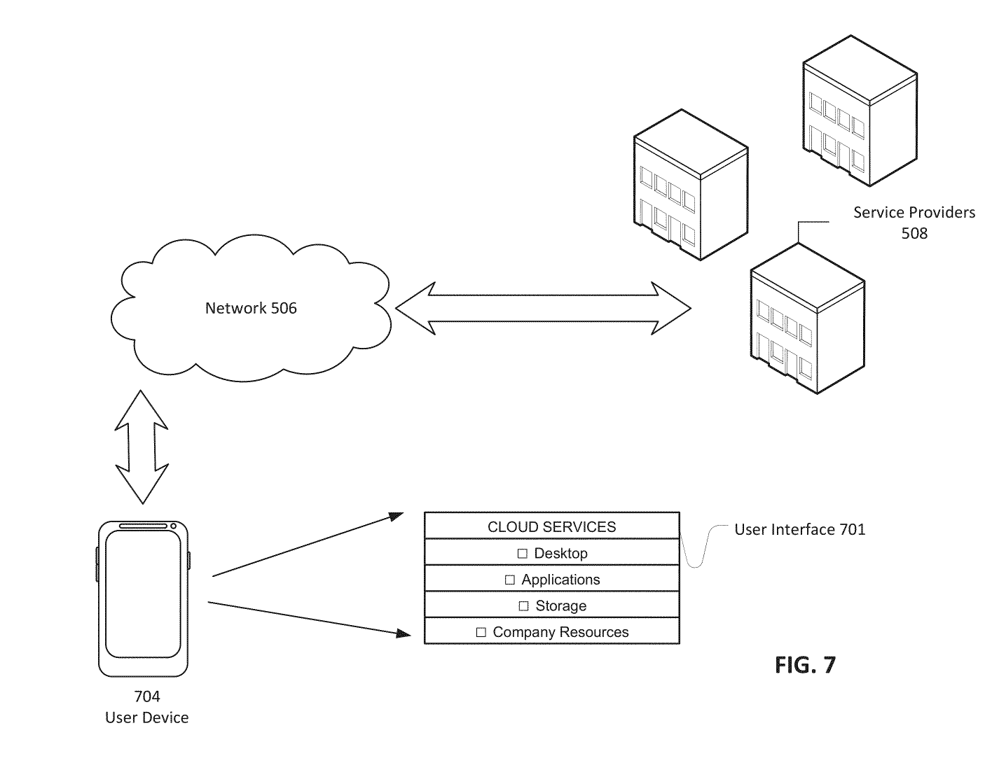

FIG. 7 depicts an example operational environment for practicing aspects of the present disclosure. In particular, FIG. 7 provides further detail to the example environment shown in FIG. 5. A user at user device 407 can access cloud computing services hosted by service providers 508 via network 506 and using a user interface 701. For example, user interface 701 may comprise a web interface through which the cloud computing services can be accessed. The user may access services such as a remote desktop, applications, and storage services. The user may also access the user's company resources that are hosted by the cloud computing services. The provider of the cloud computing services can charge a fee to the user for providing the requested services. The cloud computing services may also be configured by an administrator that configures the cloud computing services to be provided to a defined group of users such as employees of a company that provides authentication credentials.

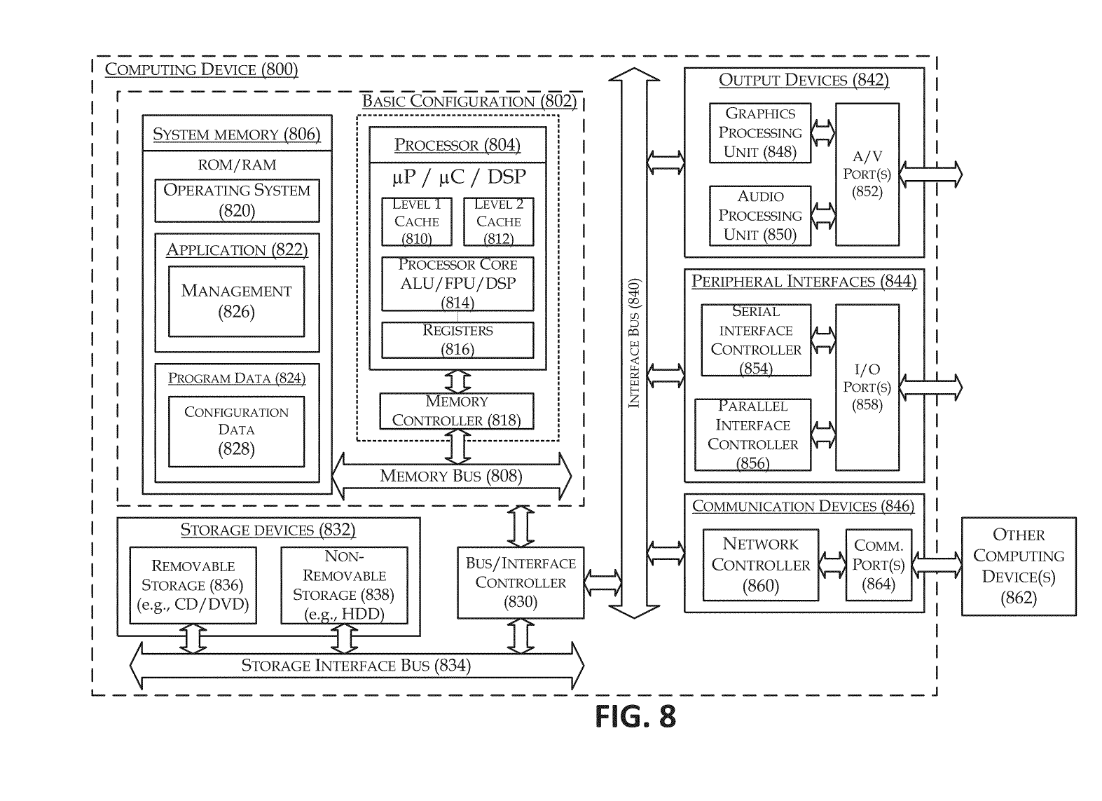

FIG. 8 depicts an example computing system wherein aspects of the present disclosure can be implemented. In particular, FIG. 8 depicts a block diagram illustrating an example computing device 800 that is arranged for managing policies in accordance with the present disclosure. In a very basic configuration 802, computing device 800 typically includes one or more processors 804 and a system memory 806. A memory bus 808 may be used for communicating between processor 804 and system memory 806.

Depending on the desired configuration, processor 804 may be of any type including but not limited to a microprocessor (μP), a microcontroller (μC), a digital signal processor (DSP), or any combination thereof. Processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, system memory 806 may be of any type including but not limited to volatile memory (such as RAM), non-volatile memory (such as ROM, flash memory, etc.) or any combination thereof. System memory 806 may include an operating system 820, one or more applications 822, and program data 824. Application 822 may include a policy management method 826 that is arranged to perform the functions as described herein including those described with respect to the processes described, for example, in FIGS. 1-4. Program data 824 may include configuration data 828 that may be useful for operation with the virtual machine migration method described above. In some embodiments, application 822 may be arranged to operate with program data 824 on operating system 820 such that that implementations of virtual machine migration may be provided as described herein. This described basic configuration 802 is illustrated in FIG. 8 by those components within the inner dashed line.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (e.g., output devices 842, peripheral interfaces 844, and communication devices 846) to basic configuration 802 via bus/interface controller 830. Example output devices 842 include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 800 may also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method comprising:
accessing one or more policies associated with a user, the one or more policies pertaining to one or more computing devices associated with the user;
determining capabilities of an additional computing device to be associated with the user;
based on the determined capabilities of the additional computing device, identifying a subset of the one or more policies that are applicable to the additional computing device;
based on the identified subset of the one or more policies, automatically generating a customized set of policies for the additional computing device; and
sending the customized set of policies to the additional computing device.

2. The method of claim 1, wherein the customized set of policies are further based on one or more of usage patterns associated with the user and access patterns for installed applications.

3. The method of claim 2, wherein the usage patterns comprise types of user contexts and the access patterns comprise one or more of frequency of access, context, persistence, and composition.

4. The method of claim 1, further comprising serializing the customized set of policies to an interoperable format prior to sending the customized set of policies to the additional computing device.

5. The method of claim 1, wherein the automatically generating the customized set of policies for the additional computing device comprises removing restrictions that not relevant to the additional computing device based on the determined capabilities of the additional computing device.

6. The method of claim 1, wherein automatically generating the customized set of policies for the additional computing device comprises:
identifying capabilities supported by the additional computing device that are not supported by current computing devices associated with the user; and
generating customized policies based on policies pertaining to at least one similar capability.

7. The method of claim 1, wherein automatically generating the customized set of policies for the additional computing device comprises incrementally adapting one of the identified subset of the one or more policies.

8. A computing device comprising at least one processor unit;
a memory communicatively coupled to the processor unit when the computing device is operational, the memory having stored thereon computer instructions that when executed by the at least one processor unit cause the computing device to:
receive a generated subset of policies for the computing device from a server, the generated subset of policies generated by the server are selected from one or more policies associated with a user based on identified capabilities of the computing device, the one or more policies pertaining to other computing devices associated with the user; and
execute one or more applications on the computing device using the generated subset of policies.

9. The computing device of claim 8, wherein the generated subset of policies are further based on one or more of usage patterns associated with the user and access patterns for installed applications.

10. The computing device of claim 9, wherein the usage patterns comprise types of user contexts and the access patterns comprise one or more of frequency of access, context, persistence, and composition.

11. The computing device of claim 8, wherein the generated subset of policies are serialized to an interoperable format.

12. The computing device of claim 8, wherein the generated subset of policies are generated in part by removal of restrictions from the one or more policies associated with the user that are not relevant to the computing device.

13. The computing device of claim 8, wherein the generated subset of policies are generated in part by identification of a capability that is supported by the computing device and is not supported by any of the other computing devices associated with the user and generation of a default policy for the identified capability based on at least one of the one or more policies having a similar capability.

14. The computing device of claim 8, wherein the generated subset of policies are generated in part by incrementally adapting the one or more policies.

15. A computer readable storage medium storing thereon computer executable instructions, said instructions comprising:
instructions for accessing one or more policies associated with a user's computing devices;
instructions for accessing attributes of an additional computing device of the user;
instructions for identifying a subset of the one or more policies that are applicable to the additional computing device based on the accessed attributes of the additional computing device;
instructions for automatically generating a customized set of policies for the additional computing device based on the identified subset of the one or more policies; and
instructions for sending the customized set of policies to the additional computing device.

16. The computer readable storage medium of claim 15, wherein the customized set of policies are further generated based on one or more of usage patterns associated with the user and access patterns for installed applications.

17. The computer readable storage medium of claim 15, further comprising instructions for serializing the customized set of policies to an interoperable format prior to sending the customized set of policies to the additional computing device.

18. The computer readable storage medium of claim 15, wherein the instructions for automatically generating the customized set of policies for the additional computing device comprises instructions for removing restrictions that are no longer relevant to the additional computing device.

19. The computer readable storage medium of claim 15, wherein the instructions for automatically generating the customized set of policies for the additional computing device comprises:
instructions for identifying capabilities supported by the additional computing device that are not supported by any of the user's computing devices; and
instructions for generating user policies based on policies pertaining to at least one similar capability.

20. The computer readable storage medium of claim 15, wherein the instructions for automatically generating the customized set of policies for the additional computing device comprises instructions for incrementally adapting one of the identified subset of the one or more policies.
